(19) United States
(12) Patent Application Publication
(10) Pub. No.: US 2024/0430609 A1
(43) Pub. Date: Dec. 26, 2024

(54) SOUND OUTPUT DEVICE

(71) Applicant: SONY GROUP CORPORATION, TOKYO (JP)

(72) Inventors: IPPEI TANAKA, TOKYO (JP); AYUMI NAKAMURA, TOKYO (JP)

(21) Appl. No.: 18/703,489

(22) PCT Filed: Oct. 11, 2022
(86) PCT No.: PCT/JP2022/037904

§ 371 Date: Apr. 22, 2024

(30) Foreign Application Priority Data
Oct. 29, 2021 (JP) 2021-177892

(51) Int. Cl. H04R 1/10

(52) U.S. Cl. CPC H04R 1/105; H04R 1/1008

(57) ABSTRACT

A pair of ear hooking arms respectively worn on left and right ears, a coupling band that is elastically deformable and couples the pair of ear hooking arms, and a speaker unit coupled to at least one of the ear hooking arm or the coupling band, in which at least a portion of the speaker unit opposes a concha auriculae and is positioned in a state of being separated from an auricle are included. The ear hooking arm includes a front side portion positioned on a front side of the auricle and a back side portion that is positioned more toward a back side than a tragus and in which at least a portion is positioned in an auriculotemporal groove. The front side portion is in contact with at least two points that are a first contact point that is a base of an upper portion of a helix and a second contact point that is a portion on a front side of the tragus in a temporal region. The back side portion is sloped in a state in which an upper end is positioned more toward a front side than a lower end and can be in contact with a third contact point and a fourth contact point positioned above and below at a base of the auricle. An extension line of a straight line connecting the first contact point and the second contact point is a first extension line. An extension line of a straight line connecting the third contact point and the fourth contact point is a second extension line. An angle between the first extension line and the second extension line is an acute angle.

### TECHNICAL FIELD

The present technology relates to a technical field of a sound output device that outputs sound.

### BACKGROUND ART

There are sound output devices that are worn on the head and used as headphones or earphones that output sound from a speaker unit. In recent years, the sound output devices have been increasingly used outdoors in addition to being used indoors.

Such sound output devices include a type that has a pair of wearing portions that are respectively pressed against left and right temporal regions, an elastically deformable coupling band that couples the pair of wearing portions, and a speaker unit that outputs sound. The pair of wearing portions are respectively pressed against the left and right temporal regions by an elastic force of the coupling band, and the coupling band is positioned along the back of the head or the top of the head (see, for example, Patent Document 1 and Patent Document 2.).

In the sound output device described in Patent Document 1, the speaker units are respectively connected to tip end sides of the pair of wearing portions. In a state in which the pair of wearing portions are pressed against the left and right temporal regions and worn, each speaker unit is inserted into a space from a concha auriculae to an external acoustic opening.

In the sound output device described in Patent Document 2, the speaker units are respectively connected to the tip end sides of the pair of wearing portions. In a state in which the pair of wearing portions are pressed against the left and right temporal regions and worn, each speaker unit is pressed against an auricle while covering the concha auriculae.

Such sound output devices are worn on the head by the pair of wearing portions being pressed against the left and right temporal regions by the coupling band being elastically deformed in a direction in which the pair of wearing portions separate from each other in left and right directions, and each speaker unit being inserted into the space from the concha auriculae to the external acoustic opening or pressed against the auricle while covering the concha auriculae. Therefore, wearing on the head can be easily performed.

### CITATION LIST

### Patent Document

Patent Document 1: Japanese Patent No. 4135043
Patent Document 2: Japanese Patent No. 4835550

### SUMMARY OF THE INVENTION

### Problems to be Solved by the Invention

Incidentally, since the human ear has individual differences in shape and size, some users may experience uneasiness from contact with the speaker unit in the worn state as a result of the speaker unit coming into contact with a portion of the auricle or pressing against the auricle.

In addition, pain or sweatiness may occur as a result of the speaker unit coming into contact with a portion of the ear. Furthermore, discomfort may occur as a result of vibrations during exercise and sounds conducted through the body during walking and the like being transmitted to an ear drum through the speaker unit.

Meanwhile, since the sound output devices such as those described above are mainly worn on the head by the wearing portions being pressed against the temporal regions by the elastic force that is as a reaction force of the elastically deformed coupling band, uneasiness and discomfort may occur as a result of a wearing position shifting depending on a magnitude of vibrations that occur during exercise, walking, and the like.

Therefore, an object of the sound output device of the present technology is to ensure a stable wearing state on an ear upon reducing occurrence of uneasiness and discomfort during wearing.

### Solutions to Problems

A sound output device according to the present technology includes: a pair of ear hooking arms respectively worn on left and right ears; a coupling band that is elastically deformable and couples the pair of ear hooking arms; and a speaker unit coupled to at least one of the ear hooking arm or the coupling band, in which at least a portion of the speaker unit opposes a concha auriculae and is positioned in a state of being separated from an auricle, in which the ear hooking arm includes a front side portion positioned on a front side of the auricle and a back side portion that is positioned more toward a back side than a tragus and in which at least a portion is positioned in an auriculotemporal groove, the front side portion is in contact with at least two points that are a first contact point that is a base of an upper portion of a helix and a second contact point that is a portion on a front side of the tragus in a temporal region, the back side portion is sloped in a state in which an upper end is positioned more toward a front side than a lower end and can be in contact with a third contact point and a fourth contact point positioned above and below at a base of the auricle, an extension line of a straight line connecting the first contact point and the second contact point is a first extension line, an extension line of a straight line connecting the third contact point and the fourth contact point is a second extension line, and an angle between the first extension line and the second extension line is an acute angle.

Therefore, in the state in which the angle between the first extension line and the second extension line is an acute angle, the front side portion is in contact with the first contact point and the second contact point, at least a portion of the back side portion is positioned in an auriculotemporal groove, and the speaker unit is worn in a non-contact state with the auricle.

### BRIEF DESCRIPTION OF DRAWINGS

FIG. 1 shows an embodiment of a sound output device of the present technology together with FIG. 2 to FIG. 21, and is a perspective view of an ear on which the sound output device is worn.

FIG. 2 is a cross-sectional view of a base of an auricle.

FIG. 3 is a perspective view of the sound output device.

FIG. 4 is a front view of the sound output device.

FIG. 5 is a planar view of the sound output device.

FIG. 6 is a side view of the sound output device.

FIG. 7 is a side view of a state in which the sound output device is worn on the ear.

FIG. 8 is a planar view of a state in which the sound output device is worn on the ear.

FIG. 9 is a rear view of a state in which the sound output device is worn on the ear.

FIG. 10 is a schematic diagram of an angle formed by a first extension line and a second extension line.

FIG. 11 is a diagram of data measured regarding the angle formed by the first extension line and the second extension line.

FIG. 12 is a front view of a sloped state of an ear hooking arm in a non-worn state.

FIG. 13 is a front view of a force generated in a coupling band and the like when the sound output device is worn on the ear.

FIG. 14 is a front view of a state in which an upper end portion of the ear hooking arm is in contact with a temporal region when the sound output device is worn on the ear.

FIG. 15 is a diagram of data measured regarding an angle of the temporal region.

FIG. 16 is a schematic diagram of a width between the temporal regions and the like.

FIG. 17 is a diagram of a state of the coupling band in which a top diagram shows a state before the coupling band is elastically deformed and a bottom diagram shows a state after the coupling band is elastically deformed.

FIG. 18 is a diagram of data measured regarding an angle on an occipital side of the temporal region.

FIG. 19 is a schematic diagram of an angle of a speaker unit in relation to a connecting line connecting a first contact point and a third contact point.

FIG. 20 is a diagram of data quantifying a degree of discomfort and the like experienced when a user wears three types of the sound output device having the ear hooking arm with different widths in an intermediate portion.

FIG. 21 is a perspective view of an example in which a through hole is formed in the speaker unit.

### MODE FOR CARRYING OUT THE INVENTION

Hereinafter, a mode for embodying the sound output device according to the present technology will be described with reference to the accompanying drawings.

In the embodiment described below, the sound output device according to the present technology is applied to headphones. However, the present technology is not limited to be applied to headphones and can be widely applied to various other sound output devices such as earphones.

### <Structure of Ear>

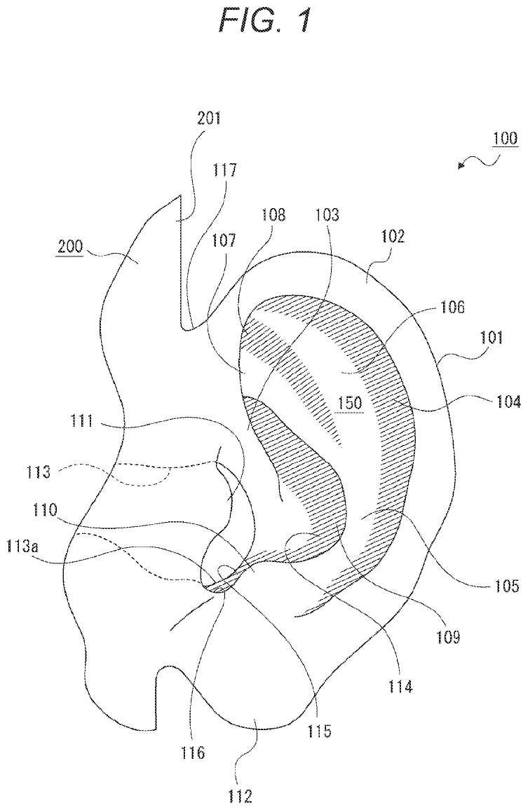

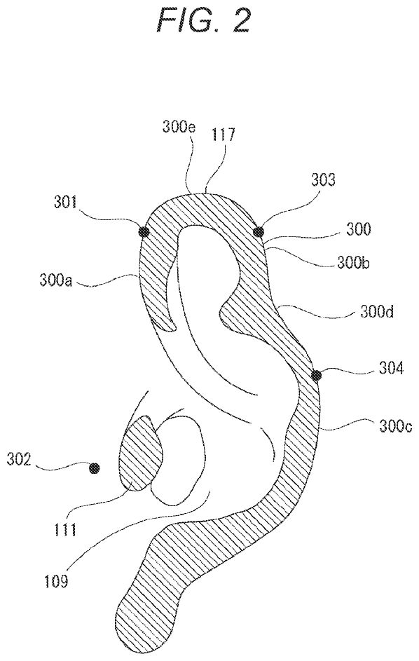

First, a structure of an ear 100 on which a sound output device 1 is worn will be described (see FIG. 1 and FIG. 2).

Ears 100 and 100 are parts of a head 200, and include auricles 101 and 101 and respective parts such as eardrums, semicircular canals, and cochleas which exist inside the head 200 (see FIG. 1). Inner portions of the auricles 101 and 101 of the head 200 are temporal regions 201 and 201, respectively, and the auricles 101 and 101 protrude leftward or rightward from the temporal regions 201 and 201, respectively.

The auricle 101 as a whole has a shallow concave shape that is open substantially to the left or substantially to the right so as to have an inner space 150, and has an outer peripheral portion having a portion referred to as a helix 102 and a convex portion referred to as a crus helicis 103 that is continuous to the helix 102 and positioned in the vicinity of the temporal region 201.

An inner portion of the helix 102 is referred to as a navicular fossa 104 having a concave shape, and a substantially lower half portion inside the navicular fossa 104 is referred to as an antihelix 105 having a convex shape. A bifurcated convex portion continuous to the antihelix 105 exists above the antihelix 105, and an outer portion and inner portion of the bifurcated portion are referred to as a superior crus of antihelix 106 and an inferior crus of antihelix 107, respectively. A portion between the superior crus of antihelix 106 and the inferior crus of antihelix 107 is referred to as a triangular fossa 108 having a concave shape, and a portion inside the antihelix 105 and the inferior crus of antihelix 107 is referred to as a concha auriculae 109 having a concave shape.

A portion that is continuous to the lower side of the antihelix 105 slightly bulges to the temporal region 201 side and is a portion called an antitragus 110. A portion on the temporal region 201 side facing the antitragus 110 is referred to as a tragus 111 slightly bulging to the antitragus 110 side, and a lower end portion that is continuous to the lower side of the helix 102 is referred to as an earlobe 112.

In a portion between the antitragus 110 and the tragus 111, an external acoustic opening 113a which is an entrance of the ear canal 113 exists, and the ear canal 113 communicates with the eardrum, the semicircular canal, and the like.

In the inner space 150, a space surrounded by the inferior crus of antihelix 107 and the crus helicis 103 is referred to as a cymba concha 114, and a space on a lower side of the cymba concha 114 is referred to as a cavum concha 115. The cymba concha 114 and the cavum concha 115 are parts of the concha auriculae 109. The cavum concha 115 communicates with the external acoustic opening 113a of the ear canal 113. In the inner space 150, a space continuous to the lower side of the cavum concha 115 and opened in a U shape is a space called an intertragic notch 116.

The inner space 150 of the auricle 101 is a space that includes the cymba concha 114, the cavum concha 115, and the intertragic notch 116, and also includes a lateral space of the navicular fossa 104, the antihelix 105, the superior crus of antihelix 106, the inferior crus of antihelix 107, and the triangular fossa 108.

A groove is formed between the auricle 101 and the temporal region 201 over a portion from an upper portion to a back portion of the auricle 101. This groove is referred to as an auriculotemporal groove 117 (see FIG. 1 and FIG. 2).

A continuous portion between the auricle 101 and the temporal region 201 is formed in a concave shape opened substantially forward in a cross-sectional shape (see FIG. 2). The continuous portion between the auricle 101 and the temporal region 201 is a base 300 of the auricle 101.

The base 300 is formed in a shape in which a front edge 300a of an upper end portion protrudes forward and is gently curved, and a portion of the front edge 300a is a first contact point 301.

A portion directly in front of the tragus 111 in the temporal region 201 is a second contact point 302. The second contact point 302 is present slightly more toward the front side than directly below the first contact point 301.

The base 300 is formed in a shape in which a back edge 300b of the upper end portion protrudes backward and is gently curved, and a back edge 300c of a center portion in an up-down direction also protrudes backward and is gently curved. A portion between the back edge 300b and the back edge 300c is formed as a concave portion 300d that recesses backward and is gently curved.

A portion of the back edge 300b is a third contact point 303 and a portion of the back edge 300c is a fourth contact point 304. The third contact point 303 is present slightly more toward the back side than directly below the second contact point 302.

The first contact point 301 and the third contact point 303 are present slightly below an upper end 300e of the base 300, and heights in the up-down direction are substantially the same. Regarding the second contact point 302 and the fourth contact point 304, the fourth contact point 304 is positioned above the second contact point 302. A distance between the first contact point 301 and the third contact point 303 is shorter than a distance between the second contact point 302 and the fourth contact point 304.

The first contact point 301, the second contact point 302, the third contact point 303, and the fourth contact point 304 are all points with which respective sections of the sound output device 1 come into contact or can come into contact in a state in which the sound output device 1 is worn on the ear 100.

### <Configuration of Sound Output Device>

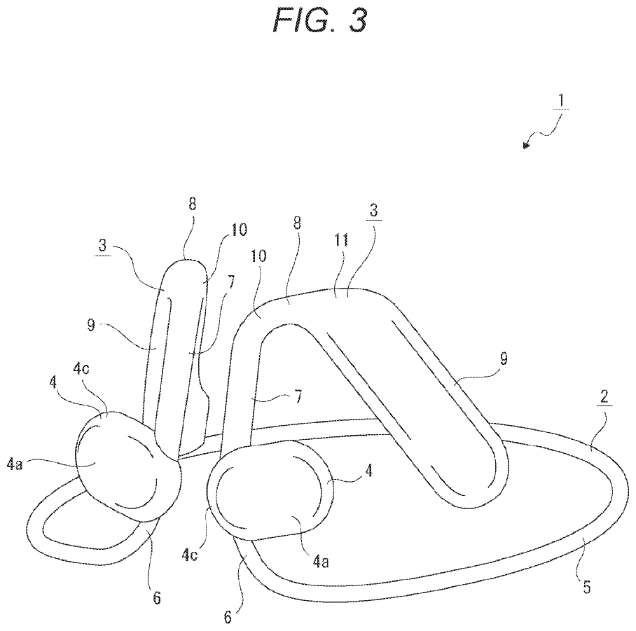

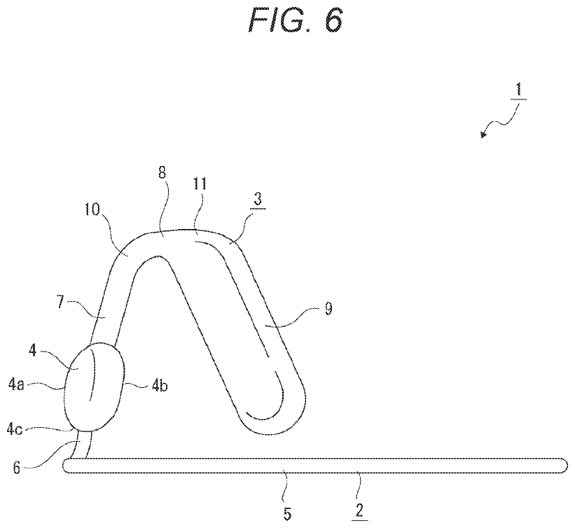

Next, a configuration of the sound output device 1 will be described below (see FIG. 3 to FIG. 6).

The sound output device 1 includes a coupling band 2, ear hooking arms 3 and 3, and speaker units 4 and 4.

Note that, in the following description of the configuration of the sound output device 1, front, back, up, down, left, and right directions in a state in which the sound output device 1 is worn on the ear 100 are described.

The coupling band 2 includes an annular portion 5 formed in a substantially arc shape of which an axial direction is the up/down direction, and upright portions 6 and 6 continuous to both ends of the annular portion 5. The coupling band 2 is elastically deformable. For example, the coupling band 2 is formed in a predetermined shape by a material having a round shaft shape, and is formed in a shape in which an angular portion is not present as a whole. As a result of an angular portion not being present in the coupling band 2, pain and discomfort in the temporal region 201 and the ear 100 do not occur even when the coupling band 2 comes into contact with the temporal region 201 and the ear 100.

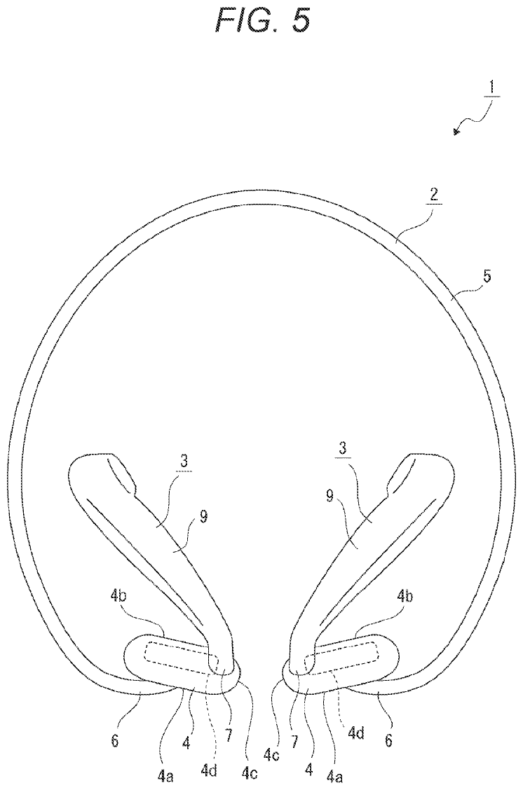

The annular portion 5 is formed in a substantially arc shape open toward the front, and is formed in a substantially arc shape that is, for example, about 280 degrees to 320 degrees in a circular portion of 360 degrees (see FIG. 5).

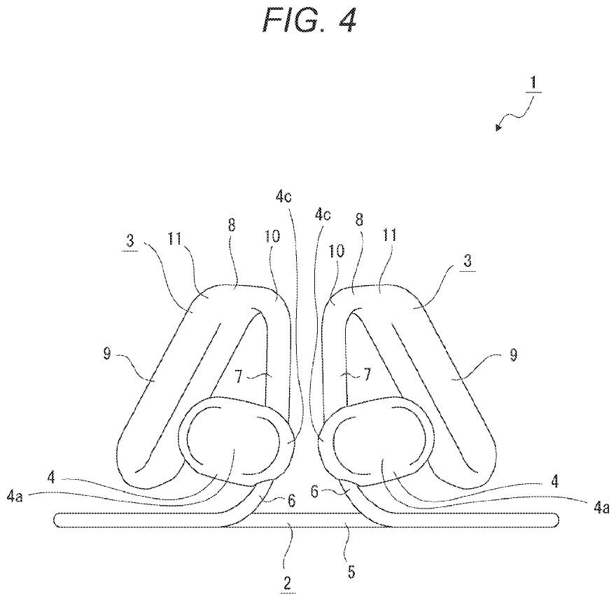

The upright portion 6 is formed in a shape that is bent into a curve (curved) (see FIG. 3 and FIG. 4). The upright portion 6 is bent so as to be displaced upward as the upright portion 6 separates from the annular portion 5. The upright portions 6 and 6 become closer to each other toward the upper side.

The ear hooking arm 3 includes a front side portion 7, an intermediate portion 8, and a back side portion 9 (see FIG. 3 to FIG. 6). For example, the ear hooking arm 3 is formed in a predetermined shape by a material having a round shaft shape or a material having a cross-sectional shape that is a circular arc or an oval, and is formed in a shape in which an angular portion is not present as a whole. As a result of an angular portion not being present in the ear hooking arm 3, pain and discomfort in the temporal region 201 and the ear 100 do not occur even when the ear hooking arm 3 comes into contact with the temporal region 201 and the ear 100.

The ear hooking arm 3 is formed in a substantially inverted V shape as a whole. The ear hooking arm 3 is sloped such that the front side portion 7 and the back side portion 9 are separated outward in a left-right direction toward the lower side.

The front side portion 7 is formed in a linear shape and is sloped such as to be displaced backward toward the upper side. Note that the front side portion 7 may be formed in a curved shape.

The intermediate portion 8 continues from an upper end portion of the front side portion 7 and is formed in a linear shape extending substantially in a front-back direction. The intermediate portion 8 has a length in the left-right direction that is shorter than a length of the front side portion 7 and a width in the left-right direction that is, for example, 7 mm or less. A continuous portion 10 between the front side portion 7 and the intermediate portion 8 is formed in a curved shape and bent such that the front side portion 7 and the intermediate portion 8 are substantially orthogonal.

The back side portion 9 continues from a back end portion of the intermediate portion 8 and sloped such as to be displaced downward as the back side portion 9 separates backward from the intermediate portion 8. The back side portion 9 is formed to be thicker than the front side portion 7 and the intermediate portion 8, and a continuous portion 11 between the intermediate portion 8 and the back side portion 9 is formed in a shape that becomes thicker from the intermediate portion 8 side toward the back side portion 9 side.

For example, the back side portion 9 is formed in a flat shape in which a width in the left-right direction is smaller than a width in the up-down direction and a thickness on left and right sides is thin. The back side portion 9 also functions as a case portion having an internal space (not shown), and respective sections such as a battery and a substrate (not shown) are housed in the internal space. A lower end of the back side portion 9 is positioned slightly below a lower end of the front side portion 7. A weight of the back side portion 9 is greater than a weight of the front side portion 7.

For example, the speaker unit 4 is formed in an oval shape. The speaker unit 4 has an outer surface that is formed in a curved surface or a flat surface continuous with the curved surface, and is formed in a shape in which an angular portion is not present as a whole. As a result of an angular portion not being present in the speaker unit 4, pain and discomfort in the temporal region 201 and the ear 100 do not occur even when the speaker unit 4 comes into contact with the temporal region 201 and the ear 100.

Note that, although an example in which the coupling band 2 is elastically deformable is described above, in the sound output device 1, the ear hooking arm 3 may also be elastically deformable in addition to the coupling band 2. In particular, the front side portion 7 and the intermediate portion 8 of the ear hooking arm 3 may be elastically deformable.

A thickness direction of the speaker unit 4 is substantially the front-back direction and the speaker unit 4 is formed in a flat shape. An outer surface of the speaker unit 4 includes a front surface 4a, a back surface 4b, and an outer peripheral surface 4c. The front surface 4a and the back surface 4b are formed in a planar shape, and the outer peripheral surface 4c is formed in a curved shape protruding outward.

A speaker device 4d is disposed inside the speaker unit 4. Sound output from the speaker device 4d is output outside through the back surface 4b. Therefore, in the sound output device 1, an axial direction of an output axis of sound is a direction connecting the front surface 4a and the back surface 4b.

The speaker unit 4 is positioned between the front side portion 7 and the upright portion 6 by a portion of an upper end portion of the outer peripheral surface 4c being coupled to a lower end of the front side portion 7 of the ear hooking arm 3, and a portion of a lower end portion of the outer peripheral surface 4c being coupled to an upper end of the upright portion 6 of the coupling band 2.

The left and right speaker units 4 and 4 have the same weight. Therefore, in a state in which the sound output device 1 is worn on the ear 100, the sound output device 1 does not easily tilt to the left and right in relation to the head 200, and a stable wearing state of the sound output device 1 on the ear 100 can be ensured.

Note that an overall center of gravity of the sound output device 1 is preferably positioned more toward the back than the center of the speaker units 4 and 4 in the front-back direction. As a result of the overall center of gravity of the sound output device 1 being positioned more toward the back than the center of the speaker units 4 and 4 in the front-back direction, the overall center of gravity of the sound output device 1 becomes closer to a joint (neck joint) in an upper portion of an atlas. Consequently, the sound output device 1 does not easily tilt in relation to the head 200 when the head 200 moves, and stability of the sound output device 1 in a state of being worn on the ear 100 can be improved.

### <Wearing of Sound Output Device on Ear>

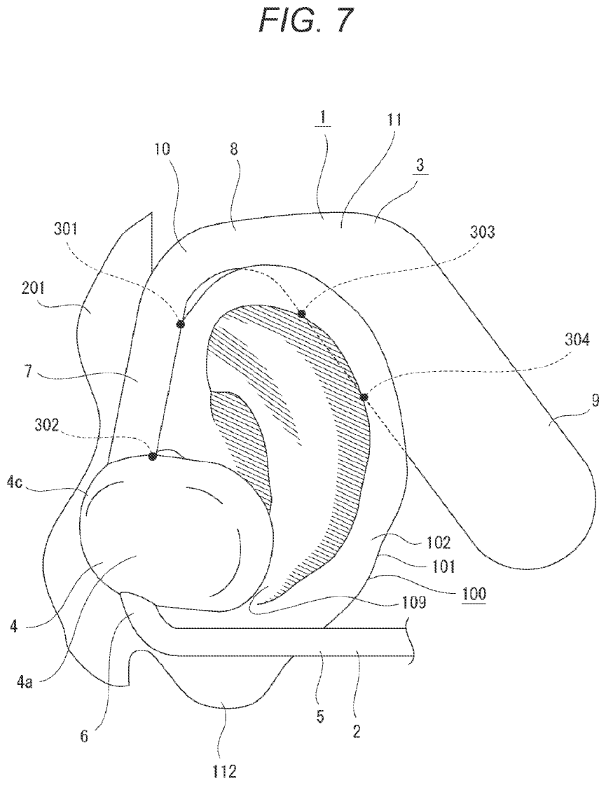

The sound output device 1 in a state of being worn on the ear 100 will be described below (see FIG. 7 to FIG. 9).

In the sound output device 1 in a non-worn state, the pair of ear hooking arms 3 and 3 are positioned closer, at about 10 mm to 40 mm, for example, in the left-right direction. When the sound output device 1 is worn on the ears 100 and 100, the user opens the ear hooking arms 3 and 3 so as to be separated in the left-right direction from the state of being positioned closer to each other, and the coupling band 2 is elastically deformed. Note that, in the sound output device 1, the pair of ear hooking arms 3 and 3 may be in contact with each other in the non-worn state. As a result of the ear hooking arms 3 and 3 being in contact with each other in the non-worn state, size reduction of the sound output device 1 in the non-worn state can be achieved.

When the ear hooking arms 3 and 3 are separated in the left-right direction and the head 200 is positioned on the inner side of the coupling band 2, the ear hooking arms 3 and 3 are positioned outside the temporal regions 201 and 201, respectively. At this time, the front side portion 7 is positioned on the front side of the auricle 101 and a portion of the back side portion 9 is inserted between the auricle 101 and the temporal region 201 and positioned in the auriculotemporal groove 117 (see FIG. 7). The intermediate portion 8 is positioned on the upper side of the auricle 101 or in the auriculotemporal groove 117.

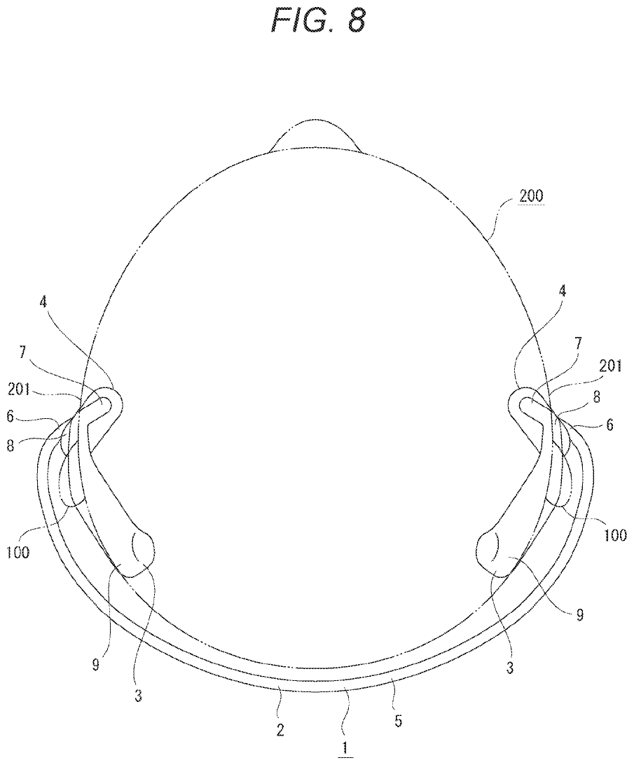

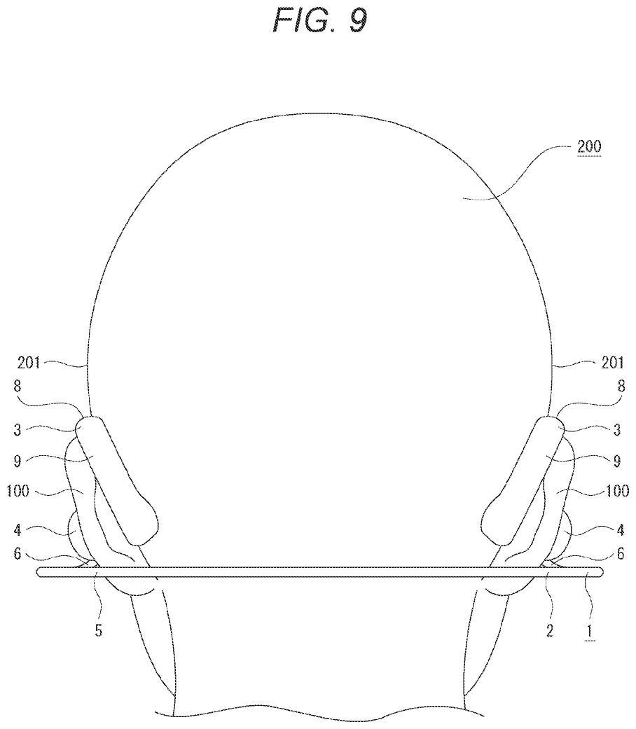

In a state in which the front side portion 7 is positioned on the front side of the auricle 101 and a portion of the back side portion 9 is positioned in the auriculotemporal groove 117 in this manner, as a result of the user removing their hand from the sound output device 1, the coupling band 2 is elastically restored, and the ear hooking arms 3 and 3 are displaced in directions approaching each other in the left-right direction. Therefore, respective sections of the ear hooking arms 3 and 3 are pressed against the temporal regions 201 and 201, respectively, by an elastic force of the coupling band 2, and the sound output device 1 is worn on the ears 100 and 100 (see FIG. 8 and FIG. 9).

In the state in which the sound output device 1 is worn on the ear 100, the coupling band 2 is positioned in a non-contact state with the head 200 from the temporal regions 201 and 201 along the back of the head. At this time, the speaker unit 4 is separated from the ear 100 and positioned in a non-contact state with the ear 100 with the back surface 4b being positioned opposing the concha auriculae 109.

In the state in which the sound output device 1 is worn on the ear 100, the ear hooking arm 3 is worn on the ear 100 in a stable state with the front side portion 7 in contact with at least two points that are the first contact point 301 and the second contact point 302 (see FIG. 7). However, the overall front side portion 7 of the ear hooking arm 3 is preferably in a state of contact with the temporal region 201. As a result of the overall front side portion 7 being in contact with the temporal region 201, a more stable wearing state of the sound output device 1 on the ear 100 can be ensured.

At this time, the ear hooking arm 3 is worn on the ear 100 in a stable state with the back side portion 9 in contact with at least the third contact point 303. However, the back side portion 9 is preferably in contact with the fourth contact point 304 in addition to the third contact point 303. As a result of the back side portion 9 being in contact with the third contact point 303 and the fourth contact point 304, a more stable wearing state of the sound output device 1 to the ear 100 can be ensured. In addition, the back side portion 9 of the ear hooking arm 3 is more preferably in contact with the temporal region 201 in a surface contact state. As a result of the back side portion 9 being in contact with the temporal region 201 in a surface contact state, an even more stable wearing state of the sound output device 1 on the ear 100 can be ensured.

Furthermore, in the state in which the sound output device 1 is worn on the ear 100, the intermediate portion 8 of the ear hooking arm 3 may be in a state of contact with the temporal region 201. As a result of the intermediate portion 8 being in a state of contact with the temporal region 201, a more stable wearing state of the sound output device 1 on the ear 100 can be ensured.

As described above, the sound output device 1 is worn on the ear 100 in a state in which the front side portion 7 is in contact with at least the first contact point 301 and the second contact point 302, and the back side portion 9 is in contact with at least the third contact point 303, and is supported at two points that are the first contact point 301 and the third contact point 303 positioned such as to be separated to the front and back, by gravity that is generated in the ear hooking arm 3. Therefore, since the front side portion 7 is less likely to be displaced obliquely forward and downward and the back side portion 9 is less likely to be displaced obliquely backward and downward, the ear hooking arm 3 is not easily shifted from the ear 100, and a stable wearing state of the sound output device 1 can be ensured. The speaker unit 4 can be kept in a non-contact state with the ear 100.

Furthermore, since the weight of the back side portion 9 is greater than the weight of the front side portion 7, a moment in a direction of falling backward with the third contact point 303 as a fulcrum is generated in the ear hooking arm 3, and a force in a direction in which the speaker unit 4 is separated from the auricle 101, particularly the tragus 111 is generated by the moment. Therefore, the position of the speaker unit 4 in relation to the auricle 101 is stabilized, and the speaker unit 4 can be reliably held in a non-contact state with the ear 100.

Moreover, the center of gravity of the speaker unit 4 is preferably positioned directly below the first contact point 301. As a result of the center of gravity of the speaker unit 4 being positioned directly below the first contact point 301, a rotational moment with the first contact point 301 as a fulcrum due to the weight of the speaker unit 4 is not generated. Therefore, the ear hooking arm 3 is not easily tilted in relation to the ear in the worn state, and a more stable wearing state can be ensured.

### <Angle of Extension Lines>

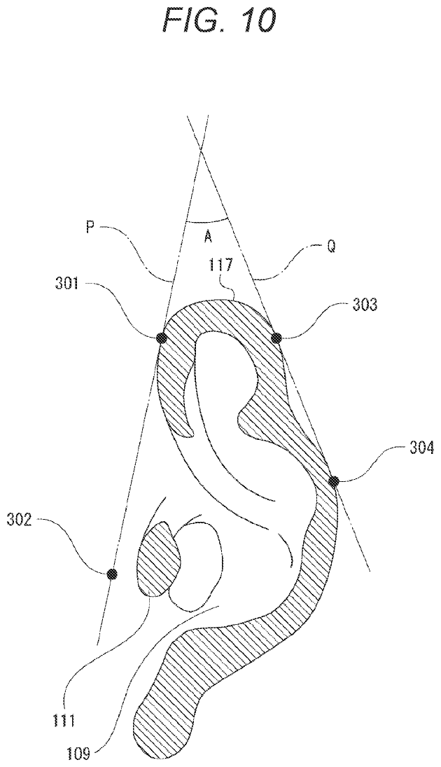

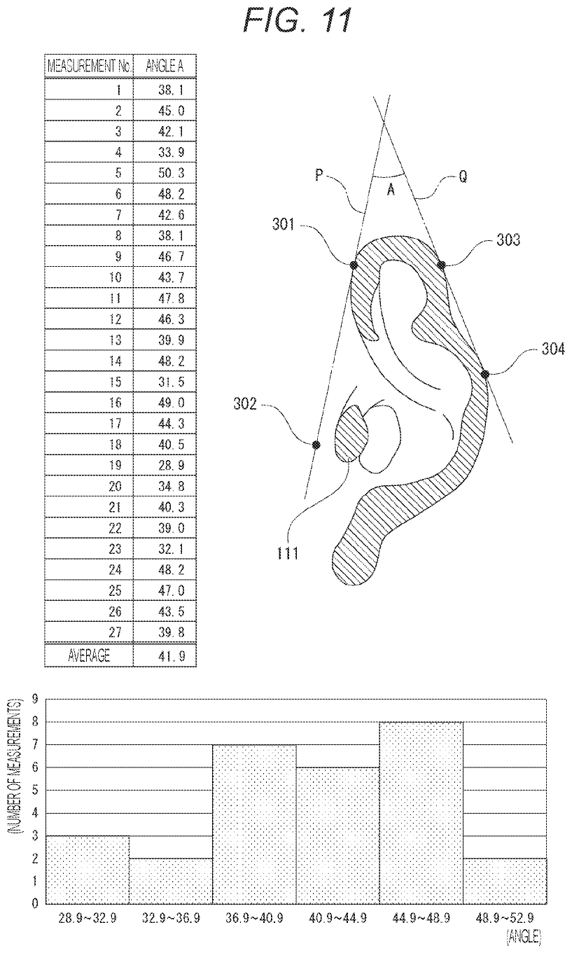

Next, an angle formed by two extension lines regarding the first contact point 301, the second contact point 302, the third contact point 303, and the fourth contact point 304 will be described (see FIG. 10 and FIG. 11).

As described above, in the state in which the sound output device 1 is worn on the ear 100, the front side portion 7 of the ear hooking arm 3 is in contact with the first contact point 301 and the second contact point 302, and the back side portion 9 of the ear hooking arm 3 is in contact with the third contact point 303 and can be in contact with the fourth contact point 304.

Should a line obtained by extending a line segment connecting the first contact point 301 and the second contact point 302 be a first extension line P and a line obtained by extending a line segment connecting the third contact point 303 and the fourth contact point 304 be a second extension line Q, the first extension line P and the second extension line Q intersect above the auricle 101 (see FIG. 10). At this time, should an angle formed by the first extension line P and the second extension line Q be an angle A, the angle A is an acute angle. Specifically, for example, the angle A is set from 40 degrees to 60 degrees.

FIG. 11 shows data measured regarding the angle A formed by the first extension line P and the second extension line Q. The measurement was performed by the first contact point 301, the second contact point 302, the third contact point 303, and the fourth contact point 304 being read from ear molds of 27 people, and the angle A formed by the first extension line P and the second extension line Q being calculated.

As a result of the measurement, the angle A was distributed over a range of 28.9 degrees to 50.3 degrees, and an average value of the angle A was 41.9 degrees.

As described above, the angle A is an acute angle in all of the measurement results. As a result of the ear hooking arm 3 being formed such that the angle A formed by the first extension line P and the second extension line Q is an acute angle, when the sound output device 1 is worn on the ear 100, the ear hooking arm 3 is supported by the first contact point 301 and the third contact point 303 on the user, and a stable wearing state of the sound output device 1 on the ear 100 can be ensured.

In particular, by the ear hooking arm 3 being formed to be from 40 degrees where the angle A is greatly distributed to 60 degrees as a result of the measurement, the wearing state of the ear hooking arm 3 on the ear 100 is stabilized regardless of individual differences in the shape, size, and the like of the temporal region 201 and the auricle 101. Consequently, a comfortable and stable wearing state without uneasiness can be ensured.

Note that, in the sound output device 1, a lower limit of the angle A may be 35 degrees, 30 degrees, or 25 degrees, and an upper limit of the angle A may be 45 degrees, 50 degrees, or 55 degrees.

### <Slope Angle of Ear Hooking Arm>

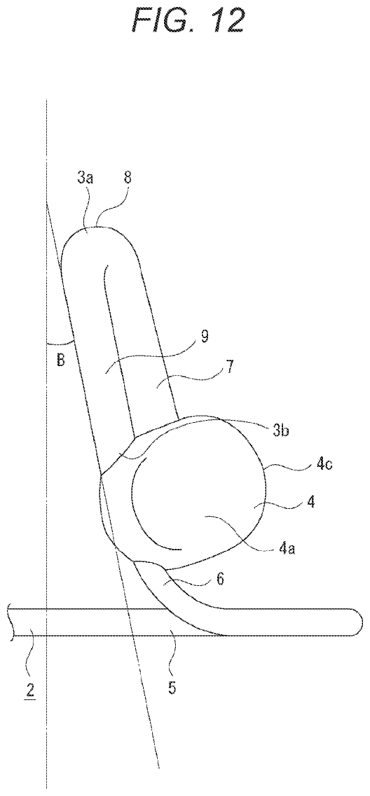

Next, a slope angle of the ear hooking arm 3 in relation to a vertical direction will be described (see FIG. 12 to FIG. 16).

In the non-worn state on the ear 100, the ear hooking arms 3 and 3 are sloped in a vertical state or in an inward leaning state such that respective upper end portions 3a are positioned more inward in the left-right direction in relation to the lower end portions 3b (see FIG. 12). A slope angle B at this time is set to, for example, 0 degrees to 20 degrees including the vertical state.

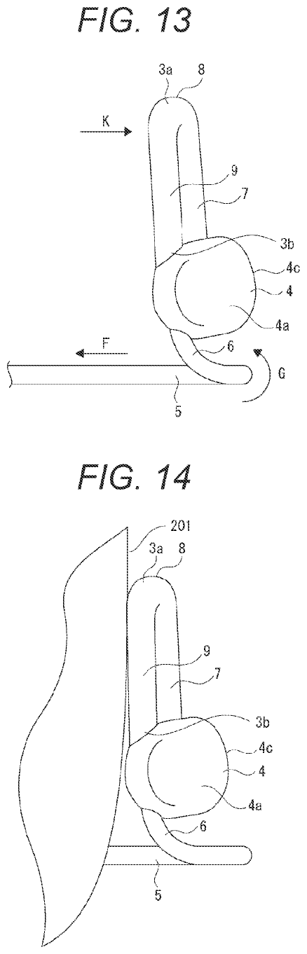

When the sound output device 1 is worn on the ear 100, the coupling band 2 is elastically deformed and opened in a direction in which the ear hooking arms 3 and 3 are separated in the left-right direction by a force K (see FIG. 13).

At this time, an elastic force that is a reaction force to return to an original state is generated in the coupling band 2, and this elastic force is a side force F. The side force F is a force that changes in proportion to a dimension in the left-right direction of the coupling band 2 that changes when the ear hooking arms 3 and 3 are separated in the left-right direction.

In addition, when the coupling band 2 is elastically deformed and opened, the ear hooking arms 3 and 3 are displaced outward in the left and right directions, respectively, and a section including the upright portions 6 of the coupling band 2 is deformed along with the displacement of the ear hooking arms 3 and 3. Therefore, the slope angle B of the ear hooking arm 3 in relation to the vertical direction changes, and an elastic force that is a reaction force is generated in the coupling band 2 with the change in the slope angle B of the ear hooking arm 3. This elastic force is a rotational moment that is a reaction force to return the coupling band 2 to the original state. This elastic force is restoring force G. The restoring force G is a force (moment) generated in a direction returning the ear hooking arm 3 to the original sloped state. The restoring force G is a force that is not dependent on the dimension in the left-right direction of the coupling band 2 that changes when the ear hooking arms 3 and 3 are separated in the left-right direction.

Since the side force F is generated in this manner when the sound output device 1 is worn on the ear 100, the ear hooking arm 3 is pressed against and brought into contact with the temporal region 201 by the side force F. At this time, the ear hooking arm 3 is sloped in the vertical state, an inward leaning state, or an outward leaning state. In addition, in general, the temporal region 201 on the front side of the ear 100 is sloped so as to be displaced toward the center side of the head 200 from the upper side to the lower side. Therefore, when the sound output device 1 is worn on the ear 100, when the ear hooking arm 3 approaches the temporal region 201 by the side force F, first, the upper end portion 3a is in a state of easily coming into contact with the temporal region 201 (see FIG. 14). Therefore, in the sound output device 1, after the upper end portion 3a comes into contact with the temporal region 201, the overall ear hooking arm 3 is pressed against and brought into contact with the temporal region 201 by the side force F and the restoring force G so as to use the upper end portion 3a as a fulcrum.

As described above, in the sound output device 1, since the ear hooking arm 3 is sloped in the vertical state or the inward leaning state in the non-worn state, the ear hooking arms 3 and 3 are easily brought into contact with the temporal regions 201 and 201, respectively, by the elastic deformation of the coupling band 2 when wearing on the ear 100. A stable wearing state of the sound output device 1 on the ear 100 can be ensured.

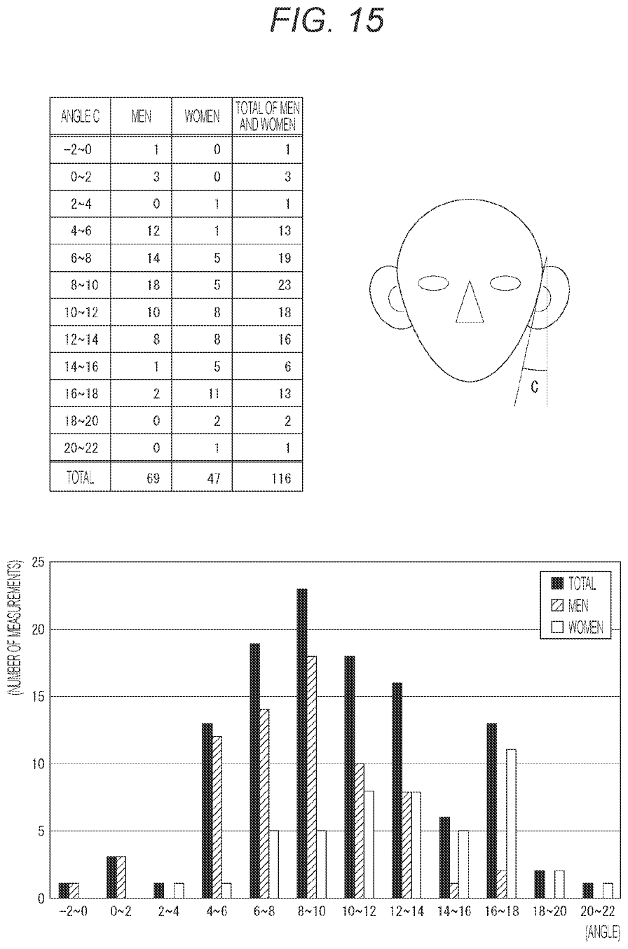

FIG. 15 shows data measured regarding an angle C at which the temporal region 201 is sloped in the left-right direction. The measurement was performed by the slope angle of the temporal region 201 for 116 men and women being actually measured.

As a result of the measurement, the angle C was distributed over a range from minus 2 degrees to 22 degrees, and the angle C was mostly in a range of 14 degrees, from 4 degrees to 18 degrees. A minus sign indicates that the temporal region 201 is sloped so as to be displaced to the side opposite to the center side of the head 200 from the upper side to the lower side.

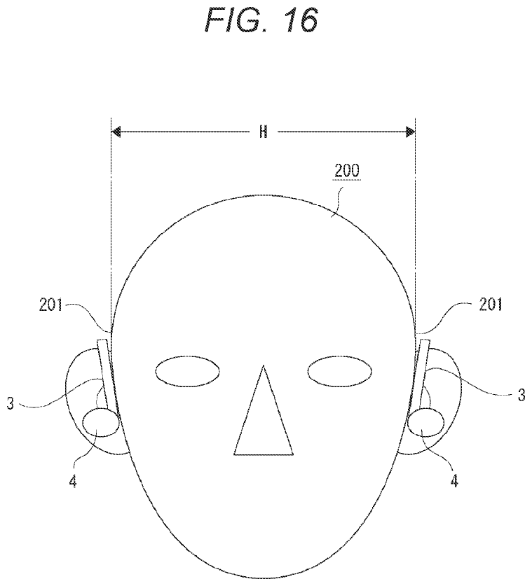

In general, a width H (see FIG. 16) of a widest portion in the left-right direction of the temporal regions 201 and 201 is 120 mm to 160 mm. A distance in the left-right direction between the ear hooking arms 3 and 3 is also set to 120 mm to 160 mm in a state in which the sound output device 1 is worn on the ears 100 and 100.

For example, in a case where the slope angle B is from 15 degrees to 20 degrees in the non-worn state, when the ear hooking arms 3 and 3 are separated in the left-right direction when wearing, the slope angle B becomes 0 degrees when the distance between the ear hooking arms 3 and 3 is 120 mm, and the ear hooking arms 3 and 3 are brought into the vertical state. Therefore, when the ear hooking arms 3 and 3 are further separated when wearing and the distance between the ear hooking arms 3 and 3 is increased beyond 120 mm, the ear hooking arms 3 and 3 are sloped to the outward leaning state, and the slope angle of the ear hooking arms 3 and 3 in the outward leaning state increases as the distance between the ear hooking arms 3 and 3 increases.

As described above, in the sound output device 1, the slope angle B of the ear hooking arms 3 and 3 in the outward leaning state increases as the distance between the ear hooking arms 3 and 3 increases beyond 120 mm, which is a minimum value of the width H. Therefore, by the slope angle B in the inward leaning state being set from 0 degrees to 20 degrees in advance, the slope angle B in the outward leaning state follows the angle C in the range of 14 degrees where most of the measurement results fall. Therefore, the overall ear hooking arms 3 and 3 are easily brought into contact with the temporal regions 201 and 201, respectively, regardless of individual differences in the shapes of the temporal regions 201 and 201 and the like. A more stable wearing state of the sound output device 1 on the ear 100 can be ensured.

### <Relationship Between Side Force and Restoring Force>

Next, a relationship between the side force F and the restoring force G generated in the coupling band 2 will be described.

As described above, the width H (see FIG. 16) between the temporal regions 201 and 201 is generally 120 mm to 160 mm. In addition, the side force F is a force that changes in proportion to the dimension in the left-right direction of the coupling band 2 that changes when the ear hooking arms 3 and 3 are separated in the left-right direction. The restoring force G is a force that does not depend on the dimension in the left-right direction of the coupling band 2 that changes when the ear hooking arms 3 and 3 are separated in the left-right direction.

When the sound output device 1 is worn on the ear 100, the side force F and the restoring force G are generated in the coupling band 2. However, as a result of the ear hooking arm 3 being pressed against the temporal region 201 by the side force F that is greater than the restoring force G, the overall ear hooking arm 3 is easily brought into contact with the temporal region 201. Occurrence of so-called point contact in which a part of the ear hooking arm 3 comes into contact with the temporal region 201 can be suppressed. Therefore, the restoring force G is preferably smaller than the side force F.

At this time, if the restoring force G is smaller than the side force F in a state in which the ear hooking arms 3 and 3 are separated from each other in the left-right direction from the non-worn state and the width H is the minimum 120 mm, the state in which the restoring force G is smaller than the side force F is maintained even in a case where the width H increases from 120 mm.

Therefore, in the sound output device 1, a spring constant of the coupling band 2, the shape of the coupling band 2, and the like are set so that the restoring force G is smaller than the side force F in the state where the ear hooking arms 3 and 3 are separated and the width H is 120 mm.

As a result of the restoring force G being made smaller than the side force F for the user having a small width H in this manner, the restoring force G becomes smaller than the side force F regardless of the size of the width H, and the overall ear hooking arm 3 can be brought into contact with the temporal region 201 regardless of differences in the width H. A stable wearing state of the sound output device 1 on the ear 100 can be ensured.

### <Distance Between Ear Hooking Arms>

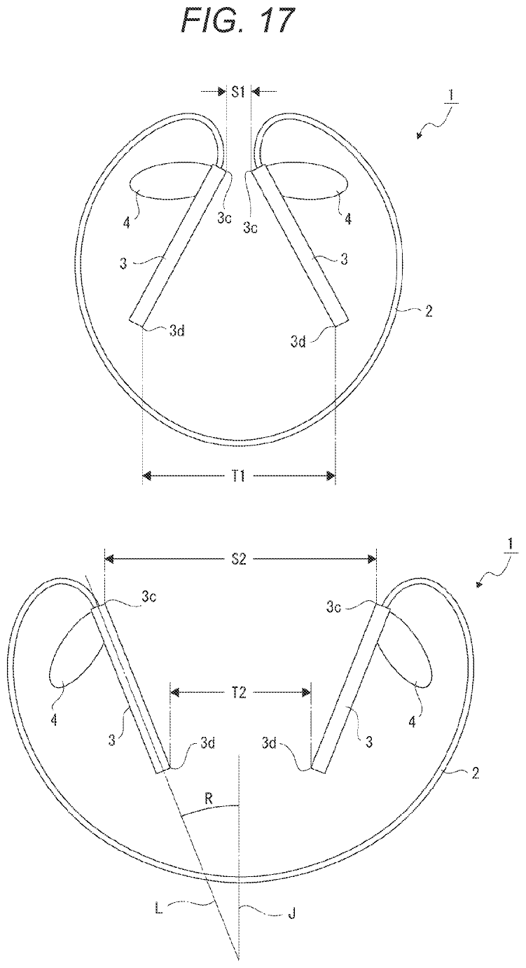

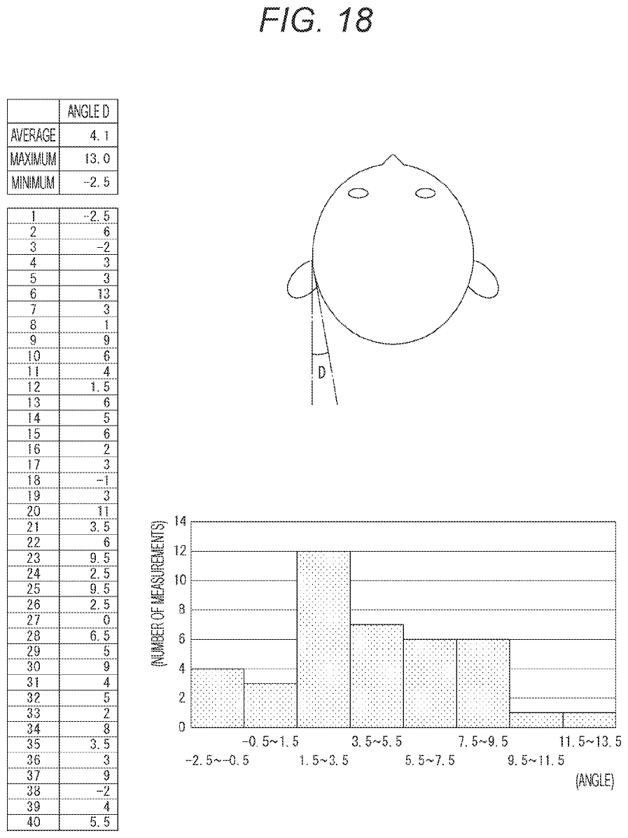

Next, a distance between the ear hooking arms 3 and 3 in a state in which the ear hooking arms 3 and 3 are separated in the left-right direction will be described (see FIG. 17 and FIG. 18).

When the sound output device 1 is worn on the ear 100, the coupling band 2 is elastically deformed and opened in a direction in which the ear hooking arms 3 and 3 are separated in the left-right direction, as described above (see FIG. 17). At this time, a distance between the front ends 3c and 3c of the ear hooking arms 3 and 3 in a state before the coupling band 2 is elastically deformed (see the top diagram in FIG. 17) is a distance S1, a distance between the front ends 3c and 3c of the ear hooking arms 3 and 3 in a state after the coupling band 2 is elastically deformed (see the bottom diagram in FIG. 17) is a distance S2, a distance between the back ends 3d and 3d of the ear hooking arms 3 and 3 in a state before the coupling band 2 is elastically deformed (see the top diagram in FIG. 17) is a distance T1, and a distance between the back ends 3d and 3d of the ear hooking arms 3 and 3 in a state after the coupling band 2 is elastically deformed (see the bottom diagram in FIG. 17) is a distance T2.

In the state before the coupling band 2 is elastically deformed, the distance S1 is less than the distance T1 (see the top diagram in FIG. 17). Meanwhile, in the state after the coupling band 2 is elastically deformed, the coupling band 2 is elastically deformed so that the positional relationship between the front ends 3c and 3c and the back ends 3d and 3d changes, and the distance S2 becomes greater than the distance T2 by the coupling band 2 elastically deforming by a certain amount or more (see the lower diagram of FIG. 17).

FIG. 18 shows data measured regarding an angle D of sloping in relation to the front-back direction of a portion on the occipital side of the temporal region 201. The measurement was performed by the slope angle of the portion on the occipital side of the temporal region 201 for 40 men and women being actually measured.

As a result of the measurement, the angle D was distributed over a range from minus 2.5 degrees to 13.0 degrees, and the angle D was mostly in a range of 8 degrees, from 1.5 degrees to 9.5 degrees. An average value of the angle D was 4.1 degrees. A minus sign indicates that the temporal region 201 is sloped so as to be displaced to the side opposite to the center side of the head 200 from the front side to the back side.

As described above, in general, the width H of the widest portion in the left-right direction of the temporal regions 201 and 201 is 120 mm to 160 mm. When the width H is 120 mm, the distance between the back ends 3d and 3d of the ear hooking arms 3 and 3 is smaller than the distance between the front ends 3c and 3c, thereby corresponding to the slope direction in relation to the front-back direction of the occipital portion side of the temporal region 201.

Therefore, in the sound output device 1, the distance between the back ends 3d and 3d of the ear hooking arms 3 and 3 is made smaller than the distance between the front ends 3c and 3c of the ear hooking arms 3 and 3 in the state in which the ear hooking arms 3 and 3 are separated and the width H is 120 mm.

Therefore, since the distance between the back ends 3d and 3d of the ear hooking arms 3 and 3 is smaller than the distance between the front ends 3c and 3c of the ear hooking arm 3 and 3 in the user having a small width H in this manner, the overall ear hooking arms 3 and 3 can be brought into contact with the temporal regions 201 and 201 by the side force F regardless of differences in the width H. A stable wearing state of the sound output device 1 on the ear 100 can be ensured.

Furthermore, in the sound output device 1, the restoring force G is preferably smaller than the side force F over the range of angle D of the user to suppress the occurrence of point contact in which a part of the ear hooking arm 3 comes into contact with the temporal region 201.

Therefore, in the sound output device 1, the restoring force G is made smaller than the side force F over a range in which an angle R (see FIG. 17) of a line segment L connecting the front end 3c and the back end 3d of the ear hooking arm 3 in relation to a reference line J extending in the front-back direction is 16 degrees or less.

Therefore, the restoring force G is smaller than the side force F regardless of the width H of the user. The overall ear hooking arms 3 and 3 can come into contact with the temporal regions 201 and 201, respectively, regardless of differences in the width H. A more stable wearing state of the sound output device 1 to the ear 100 can be ensured.

### <Others>

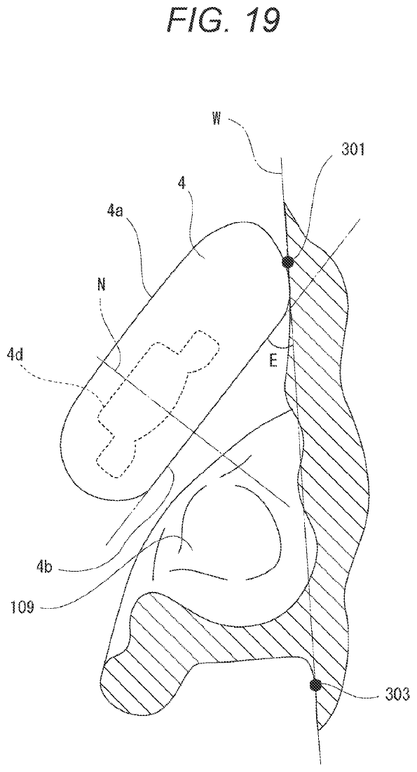

Other configurations and the like of the sound output device 1 will be described below (see FIG. 19 to FIG. 21).

In the sound output device 1, should a straight line connecting the first contact point 301 and the third contact point 303 be a connecting line W, an angle E between the connecting line W and the back surface 4b of the speaker unit 4 opposing the concha auriculae 109 is from 40 degrees to 75 degrees (see FIG. 19).

As a result of such a configuration, since an axial direction of an output axis N of the sound output from the speaker device 4d of the speaker unit 4 is a direction connecting the front surface 4a and the back surface 4b, the back surface 4b of the speaker unit 4 easily faces the concha auriculae 109 and the ear canal 113, and the sound output from the speaker device 4d can be efficiently transmitted toward the eardrum.

However, in the sound output device 1, the speaker unit 4 is more preferably positioned such that the axial direction of the output axis N of the sound output from the speaker device 4d faces the concha auriculae 109 rather than the external acoustic opening 113a. As a result of the axial direction of the output axis N intersecting the concha auriculae 109, the user is able to listen to the sound without uneasiness.

Furthermore, in the sound output device 1, as described above, the width (thickness) in the left-right direction of the intermediate portion 8 of the ear hooking arm 3 is 7 mm or less.

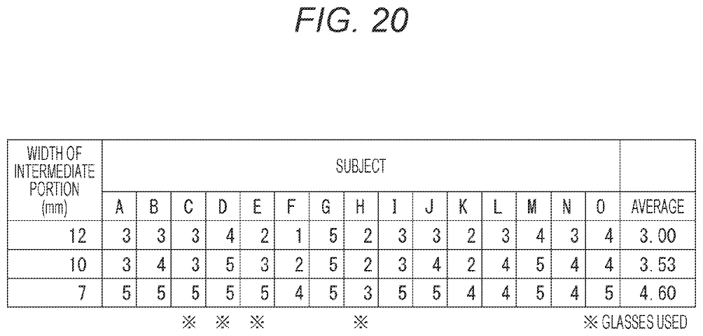

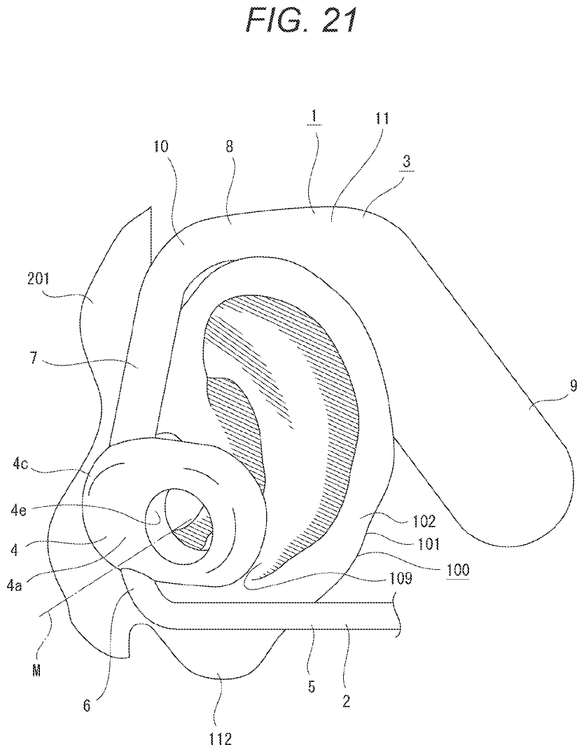

FIG. 20 shows data quantifying a degree of discomfort and the like experienced by the user when wearing three types of the sound output device 1 having the ear hooking arm 3 with different widths in the left-right direction in the intermediate portion 8.

In FIG. 20, a numerical value 1 indicates a case where sensation of the intermediate portion 8 coming into contact with the base of the auricle 101 has occurred and discomfort has occurred. A numerical value 2 indicates a case where sensation of the intermediate portion 8 coming into contact with the base of the auricle 101 has occurred but discomfort cannot be said to have occurred or not occurred. A numerical value 3 indicates a case where sensation of the intermediate portion 8 coming into contact with the base of the auricle 101 has occurred but discomfort has not occurred. A numerical value 4 indicates a case where sensation of the intermediate portion 8 coming into contact with the base of the auricle 101 cannot be said to have occurred or not occurred but discomfort has not occurred. A numerical value 5 indicates a case where sensation of the intermediate portion 8 coming into contact with the base of the auricle 101 has not occurred and discomfort has also not occurred. In FIG. 20, * indicates a case where the ear hooking arm 3 is worn in a state in which glasses are used.

An average value was 3.00 in a case where the width of the intermediate portion 8 in the left-right direction was 12 mm. The average value was 3.53 in a case where the width of the intermediate portion 8 in the left-right direction was 10 mm. The average value was 4.60 in a case where the width of the intermediate portion 8 in the left-right direction was 7 mm.

As described above, it has been found that the degree of discomfort decreases as the width of the intermediate portion 8 in the left-right direction decreases, and the degree of discomfort is significantly reduced in the case of 7 mm compared to the cases of 10 mm and 12 mm.

Therefore, by the width in the left-right direction of the intermediate portion 8 in the ear hooking arm 3 being set to 7 mm or less, the intermediate portion 8 is less likely to come into contact with the base of the auricle 101 in the auriculotemporal groove 117. Consequently, a comfortable wearing state of the sound output device 1 on the ear 100 can be ensured.

In addition, even in a case where glasses are worn on the ear 100 or in a case where hair is caught between the intermediate portion 8 and the auricle 101 or the temporal region 201, the helix 102 is hardly deformed. Occurrence of uneasiness in a state in which the sound output device 1 is worn on the ear 100 can be suppressed.

Note that a through hole 4e in which a center axis M intersects the auricle 101 may be formed in the speaker unit 4 (see FIG. 21).

Since the through hole 4e is formed in the speaker unit 4, the user experiences a sense of openness. Good wearability and improvement in design of the sound output device 1 can be achieved.

In this case, in particular, the speaker unit 4 coming into contact with the tragus 111 can be reliably prevented since the through hole 4e is formed at a position opposing the tragus 111.

In addition, a recess may be formed in the speaker unit 4 instead of the through hole 4e. In this case, as a result of the shape of the recess being formed into a shape corresponding to the shape of the tragus 111, the speaker unit 4 can be brought close to the external acoustic opening 113a while preventing the speaker unit 4 from coming into contact with the tragus 111. Sound pressure can be increased and a good listening state for sound can be ensured.

### <Present Technology>

The present technology can be configured as follows.

(1)

A sound output device including:
a pair of ear hooking arms respectively worn on left and right ears;
a coupling band that is elastically deformable and couples the pair of ear hooking arms; and
a speaker unit coupled to at least one of the ear hooking arm or the coupling band, in which at least a portion of the speaker unit opposes a concha auriculae and is positioned in a state of being separated from an auricle, in which
the ear hooking arm includes a front side portion positioned on a front side of the auricle and a back side portion that is positioned more toward a back side than a tragus and in which at least a portion is positioned in an auriculotemporal groove,
the front side portion is in contact with at least two points that are a first contact point that is a base of an upper portion of a helix and a second contact point that is a portion on a front side of the tragus in a temporal region,
the back side portion is sloped in a state in which an upper end is positioned more toward a front side than a lower end and can be in contact with a third contact point and a fourth contact point positioned above and below at a base of the auricle,
an extension line of a straight line connecting the first contact point and the second contact point is a first extension line,
an extension line of a straight line connecting the third contact point and the fourth contact point is a second extension line, and
an angle between the first extension line and the second extension line is an acute angle.
   (2)

The sound output device according to (1), in which
the angle between the first extension line and the second extension line is set from 40 degrees to 60 degrees.
   (3)

The sound output device according to (1) or (2), in which
an elastic force that is a reaction force generated in the coupling band that is elastically deformed when the pair of ear hooking arms are separated in a left-right direction is a side force,
an elastic force that is a reaction force generated in the coupling band that is elastically deformed when a slope angle of the ear hooking arm in relation to a vertical direction changes is a restoring force, and
the pair of ear hooking arms are sloped in a vertical state or such that respective upper end portions are positioned more toward an inner side in the left-right direction than lower end portions in a non-worn state on the ear.
   (4)

The sound output device according to (3), in which
the slope angle of the ear hooking arm in relation to the vertical direction is set from 0 degrees to 20 degrees.
   (5)

The sound output device according to (3) or (4), in which
the restoring force is smaller than the side force in a state in which the pair of ear hooking arms are separated in the left-right direction and a distance between both is 120 mm.
   (6)

The sound output device according to any of (3) to (5), in which
a distance between back ends of the pair of ear hooking arms is less than a distance between front ends of the pair of ear hooking arms in a state in which the pair of ear hooking arms are separated in the left-right direction and a distance between both is 120 mm.
   (7)

The sound output device according to any of (3) to (6), in which
the restoring force is smaller than the side force when an angle of a line segment connecting a front end and a back end of the ear hooking arm in relation to a reference line extending in a front-back direction is 16 degrees or less.
   (8)

The sound output device according to any of (1) to (7), in which
a straight line connecting the first contact point and the third contact point is a connecting line, and
an angle between the connecting line and a surface of the speaker unit opposing the concha auriculae is set from 40 degrees to 75 degrees.
   (9)

The sound output device according to any of (1) to (7), in which
the ear hooking arm is provided with an intermediate portion between the front side portion and the back side portion, the intermediate portion being positioned on an uppermost side in a worn state, and
a width in the left-right direction of the intermediate portion is set to 7 mm or less.
   (10)

The sound output device according to any of (1) to (9), in which
a center of gravity of the speaker unit is positioned directly below the first contact point.
   (11)

The sound output device according to any of (1) to (10), in which
a through hole of which a center axis intersects the concha auriculae is formed in the speaker unit.

### REFERENCE SIGNS LIST

201 Temporal region
100 Ear
101 Auricle
102 Helix
109 Concha auriculae
111 Tragus
117 Auriculotemporal groove
300 Base
301 First contact point
302 Second contact point
303 Third contact point
304 Fourth contact point
1 Sound output device
2 Coupling band
3 Ear hooking arm
4 Speaker unit
7 Front side portion
8 Intermediate portion
9 Back side portion
3c Front end
3d Back end
4e Through hole

1. A sound output device comprising:
a pair of ear hooking arms respectively worn on left and right ears;
a coupling band that is elastically deformable and couples the pair of ear hooking arms; and
a speaker unit coupled to at least one of the ear hooking arm or the coupling band, in which at least a portion of the speaker unit opposes a concha auriculae and is positioned in a state of being separated from an auricle, wherein
the ear hooking arm includes a front side portion positioned on a front side of the auricle and a back side portion that is positioned more toward a back side than a tragus and in which at least a portion is positioned in an auriculotemporal groove,
the front side portion is in contact with at least two points that are a first contact point that is a base of an upper portion of a helix and a second contact point that is a portion on a front side of the tragus in a temporal region,
the back side portion is sloped in a state in which an upper end is positioned more toward a front side than a lower end and can be in contact with a third contact point and a fourth contact point positioned above and below at a base of the auricle,
an extension line of a straight line connecting the first contact point and the second contact point is a first extension line,
an extension line of a straight line connecting the third contact point and the fourth contact point is a second extension line, and
an angle between the first extension line and the second extension line is an acute angle.

2. The sound output device according to claim 1, wherein
the angle between the first extension line and the second extension line is set from 40 degrees to 60 degrees.

3. The sound output device according to claim 1, wherein
an elastic force that is a reaction force generated in the coupling band that is elastically deformed when the pair of ear hooking arms are separated in a left-right direction is a side force,
an elastic force that is a reaction force generated in the coupling band that is elastically deformed when a slope angle of the ear hooking arm in relation to a vertical direction changes is a restoring force, and
the pair of ear hooking arms are sloped in a vertical state or such that respective upper end portions are positioned more toward an inner side in the left-right direction than lower end portions in a non-worn state on the ear.

4. The sound output device according to claim 3, wherein
the slope angle of the ear hooking arm in relation to the vertical direction is set from 0 degrees to 20 degrees.

5. The sound output device according to claim 3, wherein
the restoring force is smaller than the side force in a state in which the pair of ear hooking arms are separated in the left-right direction and a distance between both is 120 mm.

6. The sound output device according to claim 3, wherein
a distance between back ends of the pair of ear hooking arms is less than a distance between front ends of the pair of ear hooking arms in a state in which the pair of ear hooking arms are separated in the left-right direction and a distance between both is 120 mm.

7. The sound output device according to claim 3, wherein
the restoring force is smaller than the side force when an angle of a line segment connecting a front end and a back end of the ear hooking arm in relation to a reference line extending in a front-back direction is 16 degrees or less.

8. The sound output device according to claim 1, wherein
a straight line connecting the first contact point and the third contact point is a connecting line, and
an angle between the connecting line and a surface of the speaker unit opposing the concha auriculae is set from 40 degrees to 75 degrees.

9. The sound output device according to claim 1, wherein
the ear hooking arm is provided with an intermediate portion between the front side portion and the back side portion, the intermediate portion being positioned on an uppermost side in a worn state, and
a width in the left-right direction of the intermediate portion is set to 7 mm or less.

10. The sound output device according to claim 1, wherein
a center of gravity of the speaker unit is positioned directly below the first contact point.

11. The sound output device according to claim 1, wherein
a through hole of which a center axis intersects the concha auriculae is formed in the speaker unit.
